(19) United States
(12) Patent Application Publication
(10) Pub. No.: US 2008/0183706 A1
(43) Pub. Date: Jul. 31, 2008

(54) Voice activated keyword information system

(76) Inventor: Yi Dong, Markham (CA)

Correspondence Address: Ralph A. Dowell of DOWELL & DOWELL P.C., 2111 Eisenhower Ave, Suite 406, Alexandria, VA, 22314, US

(21) Appl. No.: 11/700,259

(22) Filed: Jan. 31, 2007

(51) Int. Cl. G06F 17/30; G10L 15/18

(52) U.S. Cl. 707/6; 704/257

(57) ABSTRACT

The present invention is a method of conducting a voice exchange with a user for providing an information search service. The method includes the steps of: receiving a voice query from a user consisting of at least one keyword; generating a query based on the at least one keyword, the query being in accordance with a predetermined model; and determining if the query will generate a unique result. If the query will generate a unique result, then obtaining a search result to the query and verbally transmitting the search result to the user through text-to-speech technology. Alternatively if the query will not generate a unique result, then conducting a voice interactive exchange to obtain additional keywords and returning to the step of generating a query. The invention also relates to a method of transmitting advertising to a user.

### FIELD OF THE INVENTION

The present invention relates generally to voice information search system, method and applicable business model.

### BACKGROUND OF THE INVENTION

We are currently in the information age and as such many people have a need to obtain information anytime, anywhere and in an easy manner. A voice information search system that can be accessed via a phone would be desirable. However, current speech recognition technology has high word error rates especially when used in a longer sentence. However, voice recognition technology can be an effective way to express meaning when used with keywords. The difficulty is to use enough keywords to obtain a unique result. Accordingly it would be desirable to provide a method of obtaining enough keywords to obtain a unique answer.

Currently there are some voice information systems that attempt to provide a system for obtaining information. However these systems require a user to select from the initial menu and subsequent menus. For example, the user might be able to choose from “stock,” “gas price,” “weather,” or “news,” categories. Thereafter the system offers another small set of choices and so on and so on. It is often a wearying and time-consuming experience for a user to obtain the desired information.

Accordingly it would be advantageous to provide a voice interactive system that is easy to use and that helps the user to easily get to a unique answer. Further it would be advantageous to provide a method of paying for such a system through advertising.

### SUMMARY OF THE INVENTION

The present invention is a method of conducting a voice exchange with a user for providing an information search service. The method includes the steps of: receiving a voice query from a user consisting of at least one keyword; generating a query based on the at least one keyword, the query being in accordance with a predetermined model; and determining if the query will generate a unique result. If the query will generate a unique result, then the method includes obtaining a search result to the query and verbally transmitting the search result to the user through text-to-speech technology. Alternatively if the query will not generate a unique result, then the method includes conducting a voice interactive exchange to obtain additional keywords by asking the user a question and returning to the step of generating a query.

In another aspect of the invention there is provided a method of transmitting advertising to a user. The method includes the steps: of receiving advertising from a customer; screening the advertising to determine if acceptable; storing the acceptable advertising for the customer; transmitting the acceptable advertising to a user; and invoicing the customer after a predetermined number of advertisements of that customer have been transmitted to a plurality of users.

The present invention provides a method whereby an interactive engine functions like an operator to communicate with a user before accessing a data source. Preferably the method of the present invention provides a method to limit the available information based on the user's profile or skill level. Further preferably the method of the present invention includes an advertising component. Although many users would not welcome advertising or would try to avoid listening to an advertisement, advertising is an effective method of funding such a system. Therefore preferably the advertising would vary in length, would vary in terms of when it is delivered and would vary depending on the user profile and other predetermined criteria.

Further features of the invention will be described or will become apparent in the course of the following detailed description.

### BRIEF DESCRIPTION OF THE DRAWINGS

The invention will now be described by way of example only, with reference to the accompanying drawings. The accompanying drawings, which are incorporated in and constitute a part of this specification, illustrate an embodiment of the invention and, together with the description, explain the invention. In the drawings:

FIG. 1 is a flow diagram of users communicating with the voice activated keyword information system of the present invention;

FIG. 2 is a flow diagram of the voice activated keyword information system of the present invention;

FIG. 3 is a flow diagram of the interactive engine of the voice activated keyword system of the present invention;

FIG. 4 is a flow diagram of the grade system that is an optional portion of the voice activated keyword information system of the present invention;

FIG. 5 is a flow diagram showing a system for managing advertisements in the voice activated keyword information system; and

FIG. 6 is a diagram showing an example of a decision tree as used in the interactive engine.

### DETAILED DESCRIPTION OF THE INVENTION

The present invention is a voice activated keyword information system, for use with a cell phone, a telephone, a IP phone or a computer. A model for providing payment through advertising is also disclosed.

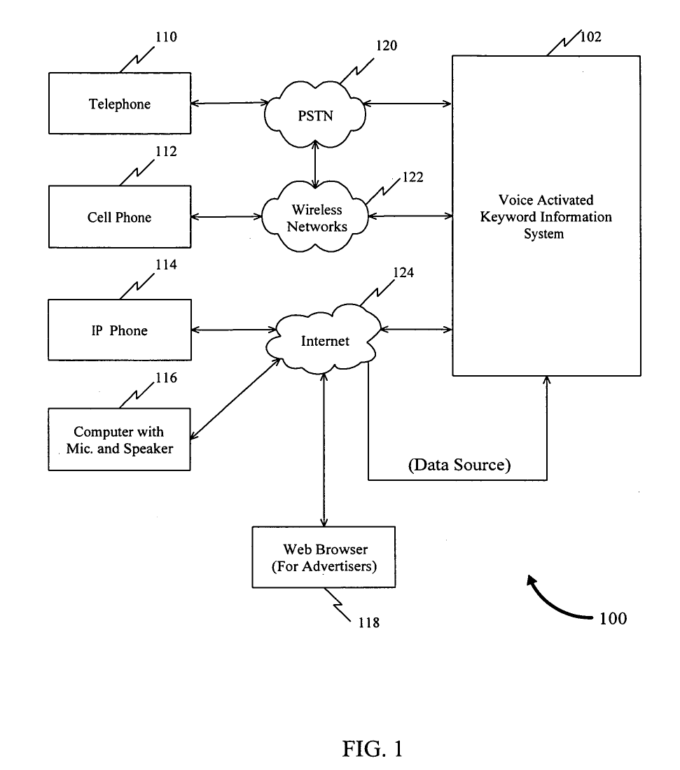

Referring to FIG. 1 an environment for the voice activated keyword information system is shown generally at 100. The specific components shown in FIG. 1 represent one example of a configuration that may be suitable for the invention and is not meant to limit the invention. Referring to FIG. 1, the voice activated keyword information system 102 receives a voice stream from public switching telephone network (PSTN) 120, wireless network 122 or the Internet 124. A user with a telephone 110 accesses a phone number via the public switching telephone network (PSTN) 120 and then connects to the voice activated keyword information system 102 directly or through wireless network 122. If the user has a cell phone 112, he/she accesses a number via wireless network 122 and then accesses the voice activated keyword information system 102 directly or through the PSTN 120. Alternatively the user accesses the voice activated keyword information system 102 through the Internet 124 via an IP phone 114 or using a computer 116. When accessing the voice activated keyword information system 102 via the Internet 124 access is established through an IP address.

In addition, an advertiser may access a website via web browser 118. As is described in more detail below, an advertiser would access the web browser for bidding an advertisement price, submitting a transfer phone number and uploading a voice file. The voice activated keyword information system 102 receives the data from the Internet 124.

Referring FIG. 1, the update component in the voice activated keyword information system 102 updates data via the Internet 124.

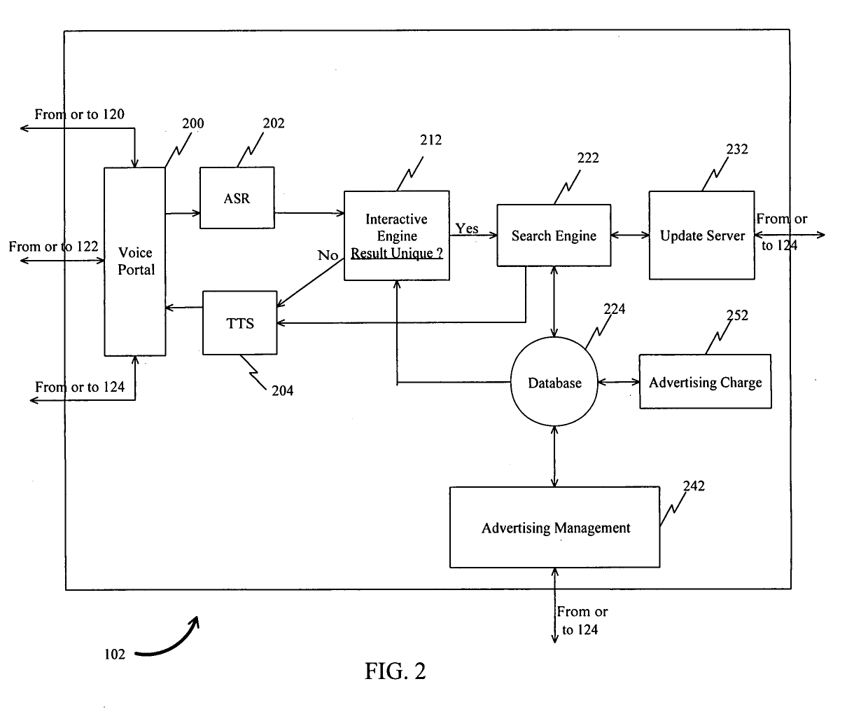

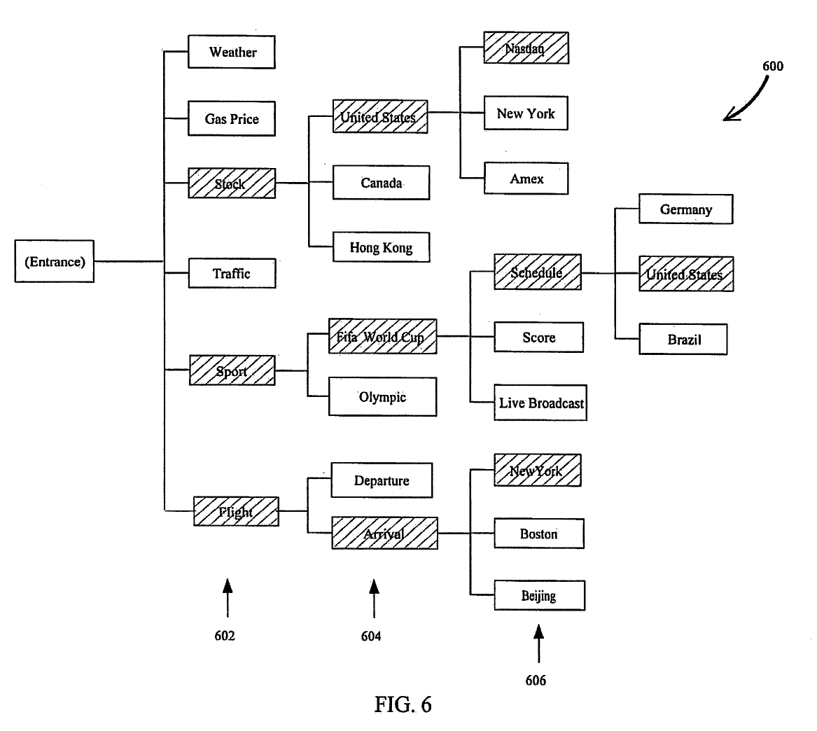

The components of the voice activated keyword information system 102 will be now described with reference to FIG. 2. The voice portal 200 receives inputs from the PSTN 120, wireless network 122 or the Internet 124 and identifies a user's call ID (phone number or IP address). The automatic speech recognition (ASR) 202 receives voice stream from the voice portal 200 and recognizes the sound stream and converts it into one or more keywords and then passes the keywords and the user's call ID to interactive engine 212. The interactive engine 212 obtains personnel profile from database 224 by the user's call ID or through user personal identification number of spoken password, decides on the next step and determines if the keywords result in a query with a unique answer. In the event that a unique solution can be generated the interactive engine will transfer the query to search engine 222. In the event that the keywords will not generate a query with a unique solution, the interactive engine will determine queries that should be asked and passes these queries to the text to speech (TTS) 204 according to a predefined model (keywords modeled in a XML tree). An example of an XML tree is shown in FIG. 6.

The text to speech TTS 204 converts a text query into a speech query and outputs the voice query to PSTN 120, wireless network 122 or the Internet 124. The steps are repeated until there is a query that will result in a unique answer. When there is a query that will result in a unique answer, the interactive engine 212 connects with the search engine 222 that obtains the answer from the update server 232. The update server 232 periodically connects with the Internet 124, updates the information and is a data source for the search engine 222. When the search engine 222 obtains the text answer, the text answer is converted to a voice answer in the TTS 204 and outputs the answer to the voice portal 200, which connects to one of the PSTN 120, wireless network 122 or the Internet 124.

In addition to answering the query the personnel data in the database 224 is updated. The personal data could include such information as the user's telephone number or IP address, as well as the frequency they use the service, the type of questions asked, the number of times they fail to achieve a unique answer, etc. As well, in the event that the call included an advertisement, the voice activated keyword information system 102 will also include an advertising charge component 252 which obtains original charge data from the database 224, balances accounts and updates advertiser's account in the database 224 and generates invoices. The advertising management component 242 receives data related to an advertisement from the Internet 124, deals with the data and passes a handled result to the database 224.

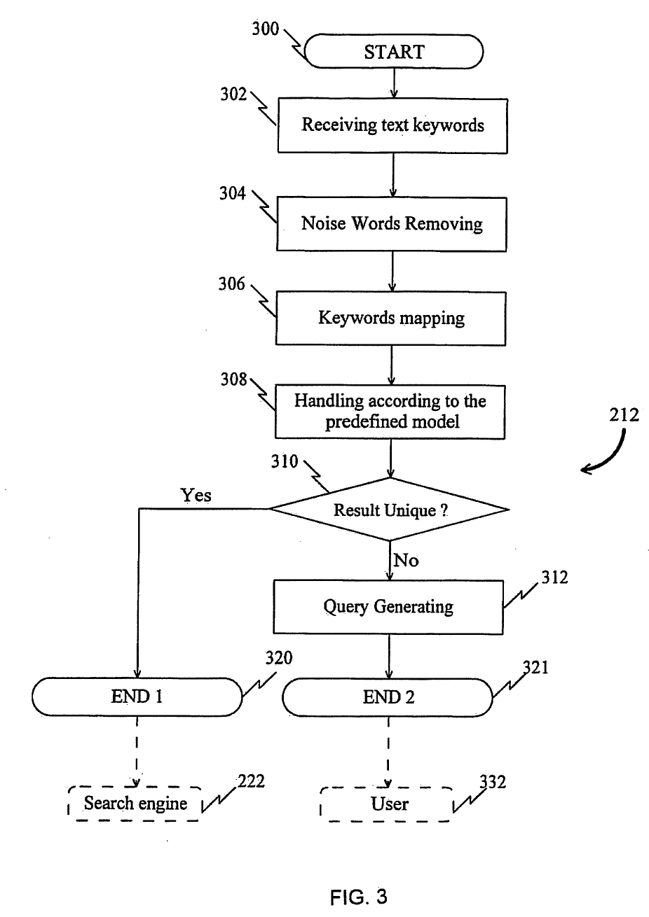

FIG. 3 is a flow diagram of one embodiment of a working process of the interactive engine 212. The interactive engine 212 receives text keywords 302, removing noise words 304, maps keywords into standard keywords defined in the model of XML tree 306, navigates the model to find context 308 and determines if there is a unique result 310. If there is a unique result then it results in “END 1” 320 and the query goes to the search engine 222. If there is not a unique result then a query is generated 312 and it results in “END 2” 321 and the query is sent to the user and with the more keywords from the answer to the query the process returns to the start 300.

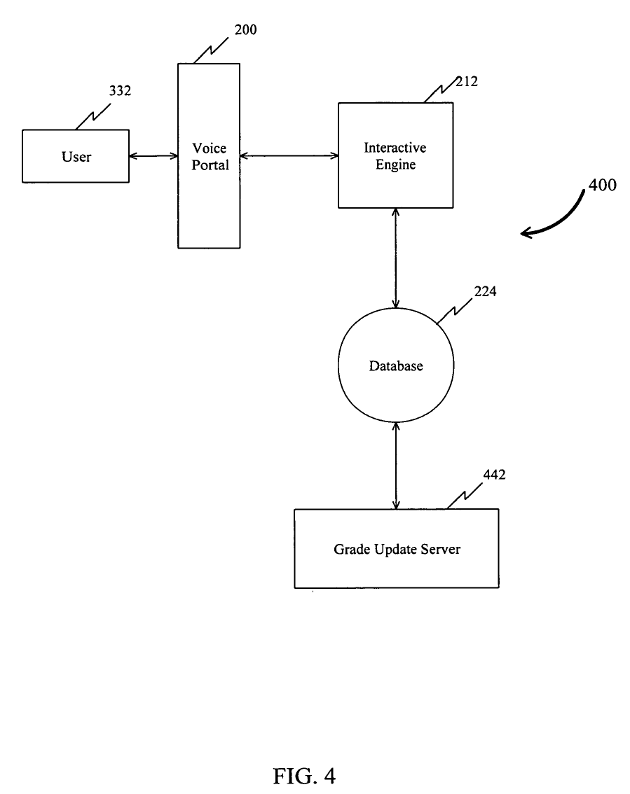

FIG. 4 illustrates a process at 400 in which a user 332 is graded by the voice activated keyword information system 102. A user 332 accesses the voice portal 200 by a phone number through the PSTN 120, wireless network 122 or an IP address through the Internet 124. The voice portal 200 may get the user's call ID (phone number or IP address) and gets the grade of the user via the interactive engine 212 by visiting the database 224. Typically for a first time user the grade will be 1 and as the user increases their familiarity with the system and their skill level, they can increase their grade by generating successful queries. The grade is updated by the grade update server 442 based on the skill of the user using the system. For example the grade may be based on the number of times the query is rejected by the system because there was no match by ASR 202. The grade may also be based on the number of times there is no unique result in a query session. As the grade level increases the user can access more and more information. For example, grade 1 may be set such that the user can access the weather, gas prices for local and surrounding areas and the local airport real time schedules. In grade 2 the user may access local news titles, local traffic report and the local sale information. In grade 3 the user may access jokes, stock quotes and the local movie schedule. In grade 4 the user may access local sport results, sport schedules and local restaurants and local retailers and bank information. It will be appreciated by those skilled in the art that the information provided at the different grade can vary as set by the service provider and that the above is only by way of example.

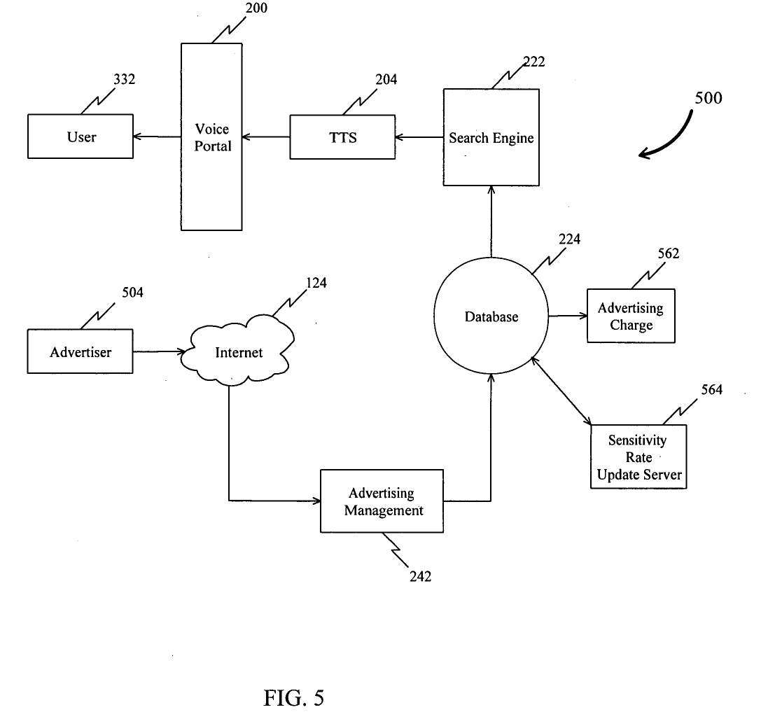

FIG. 5 is a flow diagram for an advertisement inserted in front of a search result, generally shown at 500. An advertiser 504 bids an advertisement price, appoints a keyword, submits a business phone number for the advertisement to be transferred and uploads an advertisement voice file after registering in a website via the Internet 124. Advertising Management 242 receives the data related to the advertisement, processes the data and stores the result in the database 224. A user 332 may listen to an advertisement associated with a keyword before the search result. To make sure a user listens to the whole advertisement, an advertisement is inserted at a choice of a defined percentage (for example 75%) and the length of every advertisement is different (for example one second or sixteen seconds). The component of sensitivity rate update server 564 updates the sensitivity rate related to a keywords in accordance with the using history for every user periodically.

Referring to FIG. 5, the advertising charge component 562 charges an advertiser 504 a fee in accordance to the following formula:

Fee=bidding base price+sensitivity cost;

The bidding base price is based on the price bided by an advertiser and the sensitivity cost depends on the listener's sensitivity rate or the keyword or the industry.

Referring to FIG. 6, one example of a decision tree is shown generally at 600. The decision tree has a plurality of primary branches 602. From each primary branch 602 a plurality of secondary branches 604 will stem. Tertiary branches 606 will extend from the secondary branches and so on. As an example in order to obtain the schedule for the Fifa world cup for the United States team, the keywords that will be required will be “Sport”, “Fifa World Cup”, “Schedule” and “United States”. In regard to this example the keyword “sport” can be ignored because the keyword “Fifa World Cup” is unique in the XML tree model. “Fifa World Cup” means its parent node must be “Sport”. The response to this query is a unique response and thus such a query will yield an answer. However, if the user does not provide the required keywords the result of such a query would be a question so that the keywords could be obtained. Another example is shown in FIG. 6, specifically the steps required to obtain a stock price. The keywords that are required would be “stock”, jurisdiction “United States”, exchange “Nasdaq” and the specific stock. Similarly in regard to this example since “Nasdaq” is unique only “Nasdaq” would be required. In contrast, if one required information in regard to the New York Stock Exchange, the keywords that are required would be “stock”, exchange “New York” and the specific stock (“United States” does not need to be included because it is unique between “stock” and “New York”). Without all of these keywords the system would not be able to provide an answer because it might not know the country or the exchange.

The following cases illustrate the sort of queries that a user may ask, assuming that the XML tree is as shown in FIG. 6.

### Case 1.

Inputting one or more keyword(s) that is a whole branch in the tree e.g. “Flight, Arrival, New York”, the user will get unique result.

### Case 2.

Inputting one or more keyword(s) that is not a whole branch in the tree but the part exists uniquely in the tree e.g. “Nasdaq”, the user will get unique result.

### Case 3.

Inputting one or more keyword(s) that is part of a branch in the tree and the part exists non-uniquely in the tree e.g. “New York”, the user will be asked a question “Stock or Flight? to determine the root node.

If the user is interested in obtaining information with regard to the departure time of a flight from Toronto to New York the following scenarios may ensue.

### Scenario 1

The caller inputs “Departure to New York”. The user will be provided with the current flights to New York from Pearson Airport since the user is known to be a Toronto user and only flights from Pearson airport depart to New York. Accordingly, the answer of “Pearson airport, departure to New York, CA1205 on time at 3:30 PM on terminal 3” will be given to the user.

### Scenario 2

The caller inputs “flight”. The user would be asked “Which one? Departure or Arrival”. The caller answers “departure”. The user would be asked “Departure to which city?” The caller would answer “New York”. The answer “Pearson airport, departure to New York, CA1205 on time at 3:30 PM on terminal 3” would be given to the user.

### Scenario 3

The caller inputs “New York”. The user would be asked “Which one? Weather? Local time, Flight, or Stock.” If the user is looking for information with regard to flights the user would answer “Departure”. The answer “Pearson airport, departure to New York, CA1205 on time at 3:30 PM on terminal 3” is given to the user.

### Scenario 4

The user inputs “Flight New York”. The user would be asked “Which one? Departure or arrival”. The user would answer “departure”. The system would answer “Pearson airport, departure to New York, CA1205 on time at 3:30 PM on terminal 3”

Accordingly, it will be clear to those skilled in the art that the system of the present invention is a very powerful system for easily obtaining information over a phone line. When considering the XML tree as shown in FIG. 6 it is clear that if keywords are input that do not result in a unique answer the system will ask questions so that a unique answer is obtainable. The questions may relate to a primary branch 602, a secondary branch 604, a tertiary branch 606 etc. depending on the keywords that are originally input into the system by the user.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A method of conducting a voice exchange with a user for providing an information search service comprising the steps of:
receiving a voice query from a user consisting of at least one keyword;
generating a query based on the at least one keyword, the query being in accordance with a predetermined model; and
determining if the query will generate a unique result;
if yes then obtaining a search result to the query and verbally transmitting the search result to the user through text-to-speech technology; and
if no then conducting a voice interactive exchange to obtain additional keywords and returning to the step of generating a query.

2. A method of conducting a voice exchange with a user as claimed in claim 1 wherein the voice query includes a plurality of words in a random order and further including the step of identifying the keywords in the plurality of words.

3. A method of conducting a voice exchange with a user as claimed in claim 2 wherein the predetermined model is an XML tree based on a plurality of keywords that can be used to conduct an internet search.

4. A method of conducting a voice exchange with a user as claimed in claim 3 further including the step of creating and maintaining a user profile for the user.

5. A method of conducting a voice exchange with a user as claimed in claim 4 further including the step of tracking for each user the number of steps required to obtain a unique result; tracking the number of queries made by each user; and creating the user profile for each user based on the number of steps and the number of queries.

6. A method of conducting a voice exchange with a user as claimed in claim 5 wherein each user profile is assigned a grade level and each grade level has a set of acceptable predetermined queries and further including the step of determining if the query is within the set of acceptable predetermined queries and if yes, proceeding and if no, verbally transmitting to the user that the query cannot be answered through text-to-speech technology.

7. A method of conducting a voice exchange with a user as claimed in claim 3 wherein the user connects to the information search service via one of a public switch telephone system, a voice capable wireless network and an internet connection.

8. A method of conducting a voice exchange with a user as claimed in claim 3 wherein the voice interactive exchange uses an interactive engine, the interactive engine includes the steps of referring to the XML tree, determining a branch of the tree that most closely corresponds to the keywords, determining questions that will generate keywords that will be along the XML tree.

9. A method of conducting a voice exchange with a user as claimed in claim 3 further including the step of transmitting a verbal advertisement to the user prior to transmitting the search result.

10. A method of conducting a voice exchange with a user as claimed in claim 9 wherein the verbal advertisement is transmitted in a random order.

11. A method of conducting a voice exchange with a user as claimed in claim 10 wherein the verbal advertisement is one of a short message and a long message.

12. A method of conducting a voice exchange with a user as claimed in claim 11 wherein the verbal advertisement is inserted at random times during the voice exchange.

13. A method of conducting a voice exchange with a user as claimed in claim 9 further including the step of choosing the verbal advertisement based on one of the group consisting of the keywords, the search result and a combination thereof.

14. A method of conducting a voice exchange with a user as claimed in claim 6 further including the step of transmitting a verbal advertisement to the user prior to transmitting the search result and choosing the verbal advertisement based on one of the group consisting of the keywords, the search result, the user profile, the grade level and a combination thereof.

15. A method of conducting a voice exchange with a user as claimed in claim 9 wherein the method further includes an advertising management component.

16. A method of conducting a voice exchange with a user as claimed in claim 15 wherein the advertising management component includes the steps of:
receiving verbal advertising from a customer;
screening the verbal advertising to determine if acceptable;
storing the acceptable verbal advertising for the customer;
transmitting the acceptable verbal advertising to a user; and
invoicing the customer after a predetermined number of verbal advertisements of that customer have been transmitted to a plurality of users.

17. A method of conducting a voice exchange with a user as claimed in claim 16 further including the step of conducting an auction among a plurality of customers to determine a price for transmitting the acceptable verbal advertising.

18. A method of conducting a voice exchange with a user as claimed in claim 17 wherein the auction is conducted via the Internet.

19. A method of conducting a voice exchange with a user as claimed in claim 16 further including the step of updating the verbal advertising.

20. A method of conducting a voice exchange with a user as claimed in claim 16 further including the step of choosing the user and wherein the user is based on at least one keyword used by the user.

21. A method of conducting a voice exchange with a user as claimed in claim 20 further including the step of choosing the user based on a user profile.

22. A method of conducting a voice exchange with a user as claimed in claim 16 further including the step of connecting the user to the customer.

23. A method of transmitting advertising to a user including the steps of:
receiving advertising from a customer;
screening the advertising to determine if acceptable;
storing the acceptable advertising for the customer;
transmitting the acceptable advertising to a user; and
invoicing the customer after a predetermined number of advertisements of that customer have been transmitted to a plurality of users.

24. A method of transmitting advertising to a user as claimed in claim 23 further including the step of conducting an auction among a plurality of customers to determine a price for transmitting the acceptable advertising.

25. A method of transmitting advertising to a user as claimed in claim 24 wherein the auction is conducted via the Internet.

26. A method of transmitting advertising to a user as claimed in claim 24 wherein a fee for the advertising is based on the price as determined by the auction and a sensitivity rate, and the sensitivity rate is dependent on keywords used by user and an industry rate for the customer.

27. A method of transmitting advertising to a user as claimed in claim 23 further including the step of updating the advertising.

28. A method of transmitting advertising to a user as claimed in claim 23 further including the step of choosing the user and wherein the user is based on at least one keyword used by the user.

29. A method of transmitting advertising to a user as claimed in claim 28 further including the step of choosing the user based on a user profile.

30. A method of transmitting advertising to a user as claimed in claim 23 further including the step of connecting the user to the customer.

31. A method of transmitting advertising to a user as claimed in claim 23 wherein the advertising is verbal advertising.

32. A system for conducting a voice exchange with a user for providing an information search service comprising:
a means for receiving a voice query from a user consisting of at least one keyword;
a means for generating a query based on the at least one keyword, the query being in accordance with a predetermined model; and
a means for determining if the query will generate a unique result;
if yes then obtaining a search result to the query and verbally transmitting the search result to the user through text-to-speech technology; and
if no then conducting a voice interactive exchange to obtain additional keywords and returning to the means for generating a query.

33. A system for conducting a voice exchange with a user as claimed in claim 32 wherein the voice query includes a plurality of words in a random order and further including a means for identifying the keywords in the plurality of words.

34. A system for conducting a voice exchange with a user as claimed in claim 33 wherein the predetermined model is an XML tree based on a plurality of keywords that can be used to conduct an internet search.

35. A system for conducting a voice exchange with a user as claimed in claim 34 further including a means for creating and maintaining a user profile for the user.

36. A system for conducting a voice exchange with a user as claimed in claim 35 further including a means for tracking for each user the number of steps required to obtain a unique result; tracking the number of queries made by each user; and creating the user profile for each user based on the number of steps and the number of queries.

37. A system for conducting a voice exchange with a user as claimed in claim 36 wherein each user profile is assigned a grade level and each grade level has a set of acceptable predetermined queries and further including a means for determining if the query is within the set of acceptable predetermined queries and if yes, proceeding and if no, verbally transmitting to the user that the query cannot be answered through text-to speech technology.

38. A system for conducting a voice exchange with a user as claimed in claim 34 wherein the user connects to the information search service via one of a public switch telephone system, a voice capable wireless network and an internet connection.

39. A system for conducting a voice exchange with a user as claimed in claim 34 wherein the voice interactive exchange uses an interactive engine, the interactive engine includes a means for referring to the XML tree, determining a branch of the tree that most closely corresponds to the keywords, determining questions that will generate keywords that will be along the XML tree.

40. A system for conducting a voice exchange with a user as claimed in claim 34 further including a means for transmitting a verbal advertisement to the user prior to transmitting the search result.

41. A system for conducting a voice exchange with a user as claimed in claim 40 wherein the verbal advertisement is transmitted in a random order.

42. A system for conducting a voice exchange with a user as claimed in claim 41 wherein the verbal advertisement is one of a short message and a long message.

43. A system for conducting a voice exchange with a user as claimed in claim 42 wherein the verbal advertisement is inserted at random times during the voice exchange.

44. A system for conducting a voice exchange with a user as claimed in claim 40 further including a means for choosing the verbal advertisement based on one of the group consisting of the keywords, the search result and a combination thereof.

45. A system for conducting a voice exchange with a user as claimed in claim 37 further including a means for transmitting a verbal advertisement to the user prior to transmitting the search result and choosing the verbal advertisement based on one of the group consisting of the keywords, the search result, the user profile, the grade level and a combination thereof.

46. A system for conducting a voice exchange with a user as claimed in claim 40 wherein the method further includes an advertising management component.

47. A system for conducting a voice exchange with a user as claimed in claim 46 wherein the advertising management component includes:
a means for receiving verbal advertising from a customer;
a means for screening the verbal advertising to determine if acceptable;
a means for storing the acceptable verbal advertising for the customer;
a means for transmitting the acceptable verbal advertising to a user; and
a means for invoicing the customer after a predetermined number of verbal advertisements of that customer have been transmitted to a plurality of users.

48. A system for conducting a voice exchange with a user as claimed in claim 47 further including a means for conducting an auction among a plurality of customers to determine a price for transmitting the acceptable verbal advertising.

49. A system for conducting a voice exchange with a user as claimed in claim 48 wherein the auction is conducted via the Internet.

50. A system for conducting a voice exchange with a user as claimed in claim 47 further including a means for updating the verbal advertising.

51. A system for conducting a voice exchange with a user as claimed in claim 47 further including a means for choosing the user and wherein the user is based on at least one keyword used by the user.

52. A system for conducting a voice exchange with a user as claimed in claim 51 further including a means for choosing the user based on a user profile.

53. A system for conducting a voice exchange with a user as claimed in claim 47 further including a means for connecting the user to the customer.

54. A system for transmitting advertising to a user comprising:
a means for receiving advertising from a customer;
a means for screening the advertising to determine if acceptable;
a means for storing the acceptable advertising for the customer;
a means for transmitting the acceptable advertising to a user; and
a means for invoicing the customer after a predetermined number of advertisements of that customer have been transmitted to a plurality of users.

55. A system for transmitting advertising to a user as claimed in claim 54 further including a means for conducting an auction among a plurality of customers to determine a price for transmitting the acceptable advertising.

56. A system for transmitting advertising to a user as claimed in claim 55 wherein the auction is conducted via the Internet.

57. A system for transmitting advertising to a user as claimed in claim 55 wherein a fee for the advertising is based on the price as determined by the auction and a sensitivity rate, and the sensitivity rate is dependent on keywords used by user and an industry rate for the customer.

58. A system for transmitting advertising to a user as claimed in claim 54 further including a means for updating the advertising.

59. A system for transmitting advertising to a user as claimed in claim 54 further including a means for choosing the user and wherein the user is based on at least one keyword used by the user.

60. A system for transmitting advertising to a user as claimed in claim 59 further including a means for choosing the user based on a user profile.

61. A system for transmitting advertising to a user as claimed in claim 54 further including a means for connecting the user to the customer.

62. A system for transmitting advertising to a user as claimed in claim 54 wherein the advertising is verbal advertising.
